(19) United States
(12) Patent Application Publication
(10) Pub. No.: US 2026/0253432 A1
(43) Pub. Date: Aug. 27, 2026

(54) METHOD FOR BASE CALLING AND METHOD AND APPARATUS FOR PROCESSING IMAGE DISTORTION

(71) Applicants: GENEMIND BIOSCIENCES COMPANY LIMITED, Shenzhen (CN); NANJING GENEMIND BIOSCIENCES COMPANY LIMITED, Nanjing (CN)

(72) Inventors: Linsen LI, Shenzhen (CN); Chengwei DENG, Shenzhen (CN)

(73) Assignees: GENEMIND BIOSCIENCES COMPANY LIMITED, Shenzhen (CN); NANJING GENEMIND BIOSCIENCES COMPANY LIMITED, Nanjing (CN)

(21) Appl. No.: 19/459,145

(22) Filed: Jan. 26, 2026

(30) Foreign Application Priority Data
Feb. 21, 2025 (CN) 202510200618.0

(51) Int. Cl. G06V 20/69; G06T 5/80; G06T 7/12; G06T 7/246; G06T 7/73; G06V 10/24; G06V 10/26

(52) U.S. Cl. CPC G06V 20/695; G06T 5/80; G06T 7/12; G06T 7/248; G06T 7/74; G06V 10/245; G06V 10/26; G06V 20/698; G06T 2207/10056; G06T 2207/20021

(57) ABSTRACT

The present application relates to the field of image processing technology to acquire an image of interest, and in particular, to a method for base calling, and a method and apparatus for processing image distortion. The method for base calling includes: acquiring an image of interest, where the image of interest is generated by imaging during the sequencing of a nucleic acid template on a surface of a solid substrate; the surface of the solid substrate includes a plurality of reaction sites; the nucleic acid template is located at the reaction sites; determining an initial position of the reaction site in the image of interest; correcting the initial position and determining a desired position of the reaction site in the image of interest to eliminate a position bias of the reaction site in the image of interest; acquiring a grayscale value of the desired position; and identifying, on the basis of the grayscale value, the type of a base incorporated into the nucleic acid template.

### CROSS-REFERENCE TO RELATED APPLICATIONS

This application claims the priority benefit of Chinese application serial No. 202510200618.0 filed on Feb. 21, 2025, the entirety of which is hereby incorporated by reference herein and made a part of the specification.

### TECHNICAL FIELD

The present application relates to the field of image processing technologies, and specifically, to a method for base calling and a method and apparatus for processing image distortion.

### BACKGROUND OF THE INVENTION

The process of the next-generation sequencing technology based on surface fluorescence microscopic imaging, such as sequencing by synthesis (SBS), mainly includes: (1) immobilizing a sequencing primer in a microwell on the surface of a sequencing chip; (2) binding a nucleic acid molecule of interest to the sequencing primer; (3) adding at least one of nucleotides carrying a fluorophore and a reversible terminator, such as adenine (A), guanine (G), cytosine (C), and thymine (T) (hereinafter referred to as “base A”, “base G”, “base C”, and “base T”, respectively), to bind to the nucleic acid molecule of interest and perform single base extension on the sequencing primer; (4) exciting the fluorophore with excitation light to generate fluorescence, and acquiring the fluorescence signal with a microscopic imaging system to form an image; and (5) performing base calling on the basis of the image. During one cycle of sequencing, according to the manner of adding the four nucleotides in step (3), the microscopic imaging system can perform one or more fluorescence signal acquisitions to give a plurality of images. For example, during one cycle of sequencing, the four bases (A, T, C, and G) carrying different fluorophores are simultaneously added to perform a single base extension reaction, and the microscopic imaging system can perform one fluorescence signal acquisition to give four images, which are an image containing a fluorescence signal generated by base A, an image of a fluorescence signal generated by base T, an image of a fluorescence signal generated by base C, and an image of a fluorescence signal generated by base G. Base calling software can identify the type of base incorporated into the nucleic acid molecule of interest in each microwell on the sequencing chip by extracting and processing the signal intensity in these images.

The microwells on the surface of the sequencing chip can be arranged in an array in a preset manner (such as a triangle, a quadrangle, a regular hexagon, etc.), and the spacing distance between the arrayed microwells can be set as desired. The surface of the sequencing chip is provided with marks that facilitate the location of the microwells. After the marks on the surface of the sequencing chip on the image are located, the location of the microwells and the alignment of different images can be achieved by the positions of the marks on the image, so as to accurately extract the signal intensity of each microwell and perform accurate base calling.

However, due to the instability of microscopic imaging, for example, the biased positions of the located microwells in the image due to the impact of the vibration generated by the movement of the sequencing chip by the moving platform on the camera of the microscopic imaging system as compared with the positions of the located microwells in the image when the camera is not affected by the vibration, the spacing distance between the microwells may change, resulting in bias in the microwell location and reduced base calling accuracy.

Therefore, how to solve the bias in microwell location and thereby improve the accuracy of base calling is an urgent problem to be solved in the present application.

### SUMMARY

In view of this, the present application discloses a method for base calling and a method and apparatus for processing image distortion, to eliminate the position bias of reaction sites in an image of interest, so as to accurately locate the reaction sites in the image of interest and improve the base calling accuracy.

In order to achieve the above objectives, the disclosed technical solutions are as follows:

A first aspect of the present application discloses a method for base calling, including:
acquiring an image of interest, where the image of interest is generated by imaging during the sequencing of a nucleic acid template on a surface of a solid substrate, the surface of the solid substrate includes a plurality of reaction sites, and the nucleic acid template is located at the reaction sites;
determining an initial position of the reaction site in the image of interest;
correcting the initial position to determine a desired position of the reaction site in the image of interest;
acquiring a grayscale value of the desired position of the reaction site in the image of interest; and
identifying, on the basis of the grayscale value, the type of a base incorporated into the nucleic acid template.

In some embodiments, identifying, on the basis of the grayscale value, the type of the base incorporated into the nucleic acid template, includes:
correcting the grayscale value of the desired position of the reaction site in the image of interest; and
identifying the type of the base incorporated into the nucleic acid template by using the corrected grayscale values.

In some embodiments, correcting the grayscale value of the desired position of the reaction site in the image of interest at least includes one or more of bleeding correction, crosstalk correction, phasing/prephasing correction, and normalization correction.

In some embodiments, the surface of the solid substrate includes a plurality of first marking lines extending in a first direction and parallel to each other, and a plurality of second marking lines extending in a second direction and parallel to each other; the first direction is non-parallel to the second direction.

In some embodiments, the first direction is perpendicular to the second direction.

In some embodiments, determining the initial position of the reaction site in the image of interest, includes:
determining a position of a preset reference point in an intersection region of the first marking line and the second marking line in the image of interest; and
determining the initial position of the reaction site in the image of interest according to the position of the preset reference point in the image of interest.

In some embodiments, the plurality of first marking lines and the plurality of second marking lines divide the surface of the solid substrate into a plurality of blocks;
determining the initial position of the reaction site in the image of interest, includes:
determining initial positions of reaction sites in the first marking line and/or the second marking line in the image of interest on the basis of the preset reference point, and determining initial positions of reaction sites within each block in the image of interest on the basis of the initial positions of the reaction sites in the first marking line and/or the second marking line in the image of interest.

In some embodiments, the reaction sites within each block are arranged in an array;
the reaction sites in the first marking line and/or the second marking line are linearly arranged with at least part of the reaction sites within the block.

In some embodiments, determining the initial positions of the reaction site within each block in the image of interest on the basis of the initial positions of the reaction sites in the first marking line and/or the second marking line in the image of interest, includes:
determining the initial positions of the reaction site within each block in the image of interest according to the uniform linear interpolation method and the positions of the reaction sites in the first marking line and/or the second marking line.

In some embodiments, correcting the initial position to determine the desired position of the reaction site in the image of interest, includes:
dividing each block in the image of interest into N sub-regions,
where each sub-region includes at least one reaction site in the first marking line and/or the second marking line;
moving the reaction sites in the first marking line and/or the second marking line in the sub-region in the first direction and/or the second direction to correct the initial positions of the reaction sites in the first marking line and/or the second marking line in the image of interest, so as to acquire desired positions of the reaction sites in the first marking line and/or the second marking line in the image of interest;
determining a movement amount of the reaction sites in the first marking line and/or the second marking line from the initial positions to the desired positions; and
correcting the remaining reaction sites in the sub-region based on the movement amount to determine desired positions of the remaining reaction sites in the sub-region in the image of interest, where N is a natural number greater than or equal to 1.

In some embodiments, determining the movement amount of the reaction sites in the first marking line and/or the second marking line from the initial positions to the desired positions, includes:
correcting, after each movement of the reaction sites in the first marking line and/or the second marking line in the sub-region, the remaining reaction sites in the sub-region by the movement amount of the movement, and evaluating the accuracy of the positions of the remaining reaction sites in the corrected sub-region; and
determining the movement amount of the reaction sites in the first marking line and/or the second marking line from the initial positions to the desired positions according to the evaluation result.

In some embodiments, determining the movement amount of the reaction sites in the first marking line and/or the second marking line from the initial positions to the desired positions, includes:
determining a movement amount of moving the reaction sites in the first marking line and/or the second marking line from the initial positions to the desired positions in the i+1^{th} sub-region of the N sub-regions by using a movement amount of moving the reaction sites in the first marking line and/or the second marking line from the initial positions to the desired positions in the i^{th} sub-region of the N sub-regions,
where i is a non-zero natural number <N.

In some embodiments, determining the movement amount of moving the reaction sites in the first marking line and/or the second marking line from the initial positions to the desired positions in the i+1^{th} sub-region of the N sub-regions by using the movement amount of moving the reaction sites in the first marking line and/or the second marking line from the initial positions to the desired positions in the i^{th} sub-region of the N sub-regions, includes:
traversing within a preset movement range according to a preset step length on the basis of the movement amount of the reaction sites in the first marking line and/or the second marking line in the i^{th} sub-region from the initial position to the desired position in the i^{th} sub-region;
correcting the remaining reaction sites in the i+1^{th} sub-region by the movement amount of each movement, and evaluating the accuracy of the positions of the remaining reaction sites in the corrected i+1^{th} sub-region; and
determining the movement amount of the reaction sites in the first marking line and/or the second marking line from the initial positions to the desired positions according to the evaluation result.

A second aspect of the present application discloses a method for processing image distortion, including:
acquiring an image of interest, where the image of interest is generated by imaging a surface of a solid substrate, and the surface of the solid substrate includes a plurality of reaction sites;
determining an initial position of the reaction site in the image of interest; and
correcting the initial position of the reaction site in the image of interest and determining a desired position of the reaction site in the image of interest to eliminate a position bias of the reaction site in the image of interest.

In some embodiments, the surface of the solid substrate includes a plurality of first marking lines extending in a first direction and parallel to each other, and a plurality of second marking lines extending in a second direction and parallel to each other; the first direction is non-parallel to the second direction.

In some embodiments, the first direction is perpendicular to the second direction.

In some embodiments, determining the initial position of the reaction site in the image of interest, includes:
determining a position of a preset reference point in an intersection region of the first marking line and the second marking line in the image of interest; and
determining the initial position of the reaction site in the image of interest according to the position of the preset reference point in the image of interest.

In some embodiments, the plurality of first marking lines and the plurality of second marking lines divide the surface of the solid substrate into a plurality of blocks;
determining the initial position of the reaction site in the image of interest, includes:
determining initial positions of reaction sites in the first marking line and/or the second marking line in the image of interest on the basis of the preset reference point, and determining initial positions of reaction sites within each block in the image of interest on the basis of the initial positions of the reaction sites in the first marking line and/or the second marking line in the image of interest.

In some embodiments, the reaction sites within each block are arranged in an array;
the reaction sites in the first marking line and/or the second marking line are arranged in a straight line with at least part of the reaction sites within the block.

In some embodiments, determining the initial positions of the reaction site within each block in the image of interest on the basis of the initial positions of the reaction sites in the first marking line and/or the second marking line in the image of interest, includes:
determining the initial positions of the reaction site within each block in the image of interest according to the uniform linear interpolation method and the positions of the reaction sites in the first marking line and/or the second marking line.

In some embodiments, correcting the initial position of the reaction site in the image of interest and determining the desired position of the reaction site in the image of interest to eliminate the position bias of the reaction site in the image of interest, includes:
dividing each block in the image of interest into N sub-regions, where each sub-region includes at least one reaction site in the first marking line and/or the second marking line;
moving the reaction sites in the first marking line and/or the second marking line in the sub-region in the first direction and/or the second direction to correct the initial positions of the reaction sites in the first marking line and/or the second marking line in the image of interest, so as to acquire desired positions of the reaction sites in the first marking line and/or the second marking line in the image of interest;
determining a movement amount of the reaction sites in the first marking line and/or the second marking line from the initial positions to the desired positions; and
correcting the remaining reaction sites in the sub-region based on the movement amount and determining desired positions of the remaining reaction sites in the sub-region in the image of interest to eliminate the position bias of the reaction site in the image of interest, where N is a natural number greater than or equal to 1.

In some embodiments, determining the movement amount of the reaction sites in the first marking line and/or the second marking line from the initial positions to the desired positions, includes:
correcting, after each movement of the reaction sites in the first marking line and/or the second marking line in the sub-region, the remaining reaction sites in the sub-region by the movement amount of the movement, and evaluating the accuracy of the positions of the remaining reaction sites in the corrected sub-region; and
determining the movement amount of the reaction sites in the first marking line and/or the second marking line from the initial positions to the desired positions according to the evaluation result.

In some embodiments, determining the movement amount of the reaction sites in the first marking line and/or the second marking line from the initial positions to the desired positions, includes:
determining a movement amount of moving the reaction sites in the first marking line and/or the second marking line from the initial positions to the desired positions in the i+1^{th} sub-region of the N sub-regions by using a movement amount of moving the reaction sites in the first marking line and/or the second marking line from the initial positions to the desired positions in the i^{th} sub-region of the N sub-regions,
where i is a non-zero natural number <N.

In some embodiments, determining the movement amount of moving the reaction sites in the first marking line and/or the second marking line from the initial positions to the desired positions in the i+1^{th} sub-region of the N sub-regions by using the movement amount of moving the reaction sites in the first marking line and/or the second marking line from the initial positions to the desired positions in the i^{th} sub-region of the N sub-regions, includes:
traversing within a preset movement range according to a preset step length on the basis of the movement amount of the reaction sites in the first marking line and/or the second marking line in the i^{th} sub-region from the initial position to the desired position in the i^{th} sub-region;
correcting the remaining reaction sites in the i+1^{th} sub-region by the movement amount of each movement, and evaluating the accuracy of the positions of the remaining reaction sites in the corrected i+1^{th} sub-region; and
determining the movement amount of the reaction sites in the first marking line and/or the second marking line from the initial positions to the desired positions according to the evaluation result.

A third aspect of the present application discloses an apparatus for base calling, including:
a first acquisition unit, configured for acquiring an image of interest, where the image of interest is generated by imaging during the sequencing of a nucleic acid template on a surface of a solid substrate, the surface of the solid substrate includes a plurality of reaction sites, and the nucleic acid template is located at the reaction sites;
a first determination unit, configured for determining an initial position of the reaction site in the image of interest;
a first correction unit, configured for correcting the initial position to determine a desired position of the reaction site in the image of interest;
a second acquisition unit, configured for acquiring a grayscale value of the desired position of the reaction site in the image of interest; and
an identification unit, configured for identifying, on the basis of the grayscale value, the type of a base incorporated into the nucleic acid template.

A fourth aspect of the present application discloses an apparatus for processing image distortion, including:
a third acquisition unit, configured for acquiring an image of interest, where the image of interest is generated by imaging a surface of a solid substrate, and the surface of the solid substrate includes a plurality of reaction sites;
a second determination unit, configured for determining an initial position of the reaction site in the image of interest; and
a second correction unit, configured for correcting the initial position of the reaction site in the image of interest and determining a desired position of the reaction site in the image of interest to eliminate a position bias of the reaction site in the image of interest.

A fifth aspect of the present application discloses a computer-readable storage medium having a program stored thereon, where the program is executable by a processor to implement the method according to any one of the first aspect and the second aspect.

As can be seen from the above technical solutions, the present application discloses a method for base calling and a method and apparatus for processing image distortion. The method for base calling includes: acquiring an image of interest, where the image of interest is generated by imaging during the sequencing of a nucleic acid template on a surface of a solid substrate; the surface of the solid substrate includes a plurality of reaction sites; the nucleic acid template is located at the reaction sites; determining an initial position of the reaction site in the image of interest; correcting the initial position and determining a desired position of the reaction site in the image of interest to eliminate a position bias of the reaction site in the image of interest; acquiring a grayscale value of the desired position of the reaction site in the image of interest; and identifying, on the basis of the grayscale value, the type of a base incorporated into the nucleic acid template. The above solution can determine the initial position of the reaction site in the image of interest, correct the initial position, and determine the desired position of the reaction site on the image of interest to eliminate the position bias of the reaction site in the image of interest, thereby accurately locating the reaction site in the image of interest and improving the base calling accuracy.

### BRIEF DESCRIPTION OF THE DRAWINGS

To more clearly illustrate the technical solutions in the examples of the present application or in the prior art, the drawings required for use in the description of the embodiments or the prior art will be briefly described below. It is obvious that the drawings in the description below are only some examples of the present application, and other drawings can be derived from the provided drawings by those of ordinary skill in the art without creative efforts.

FIG. 1 is a schematic flow chart of a method for base calling according to the embodiments of the present application;

FIG. 2 is a schematic view of the positions of preset reference points in an image of interest according to the embodiments of the present application;

FIG. 3 is a schematic view of movement fluctuation of reaction sites in the X and Y directions according to the embodiments of the present application;

FIG. 4 is a schematic view of the marking of cross points and reaction sites according to the embodiments of the present application;

FIG. 5 is a schematic view of an image of interest according to the embodiments of the present application;

FIG. 6 is a schematic view of comparison of results using different base calling processes according to the embodiments of the present application;

FIG. 7 is a schematic view of another comparison of results using different base calling processes according to the embodiments of the present application;

FIG. 8 is a schematic view of the effect of position correction on reaction sites according to the embodiments of the present application;

FIG. 9 is a schematic view of the optimization result in the Y direction in the image according to the embodiments of the present application;

FIG. 10 is a schematic view of a method for processing image distortion according to the embodiments of the present application;

FIG. 11 is a schematic view of an apparatus for base calling according to the embodiments of the present application;

FIG. 12 is a schematic view of an apparatus for processing image distortion according to the embodiments of the present application; and

FIG. 13 is a schematic view of an electronic device according to the embodiments of the present application.

### DETAILED DESCRIPTION OF THE INVENTION

The technical solutions of the examples of the present application will be clearly and completely described below with reference to the drawings of the examples of the present application, and apparently, the described examples are only a part of the examples of the present application instead of all examples of the present application. On the basis of the examples of the present application, all other examples obtained by those of ordinary skill in the art without creative efforts shall fall within the protection scope of the present application.

In the present application, the terms “include”, “comprise”, and any other variants thereof are intended to encompass a non-exclusive inclusion, such that a process, a method, an object, or a device that includes a list of elements not only includes those elements but also includes other elements which are not expressly listed, or further includes elements inherent to such a process, method, product, or device. An element defined by “comprising a . . . ” does not, without further constraints, exclude the presence of additional identical elements in the process, method, object, or device that includes the element.

It should be noted that, in this context, the term “solid substrate” may be any solid support that can be used to immobilize nucleic acid sequences, such as nylon membrane, glass sheet, plastic, silicon sheet, magnetic beads, etc. Illustratively, the solid substrate is a glass substrate with arrayed microwells, and the spacing distance between the microwells may be set as desired. Illustratively, the spacing distance between two adjacent microwells on the surface of the glass substrate may be 200 nm, 250 nm, 300 nm, 350 nm, 400 nm, 450 nm, 500 nm, 550 nm, 600 nm, 650 nm, 700 nm, 750 nm, 800 nm, 850 nm, etc. Preferably, the spacing distances between two adjacent microwells on the surface of the glass substrate are equal.

The term “reaction site” may be a region where a biochemical reaction is performed. For example, the position of each microwell on the surface of the glass substrate mentioned above may correspond to one reaction site, and the reaction site may be used to immobilize a nucleic acid template.

The term “sequencing” refers to sequence determination, and is used interchangeably with “nucleotide sequencing” to refer to the determination of base order in nucleotide sequences. For example, the sequencing may include sequencing by synthesis (SBS), DNA sequencing, and/or RNA sequencing; may include long fragment sequencing and/or short fragment sequencing (the long fragment and short fragment are defined relatively; for example, nucleotide molecules longer than 1 Kb, 2 Kb, 5 Kb, or 10 Kb may be referred to as long fragments, and nucleotide molecules shorter than 1 Kb or 800 bp may be referred to as short fragments); or may also include double-end sequencing, single-end sequencing, and/or paired-end sequencing (the double-end sequencing or paired-end sequencing may refer to the reading of any two segments or portions of the same nucleotide molecule that are not completely overlapping).

In the present application, the sequencing may be performed through a sequencing platform, which may be selected from, for example, but not limited to, the Hiseq/Miseq/Nextseq/Novaseq sequencing platform (Illumina), the BGISEQ and MGISEQ/DNBSEQ platforms (BGI), and single-molecule sequencing platforms, and the like.

Generally, the sequencing platform can determine the type of nucleotide/base at any designated position on the nucleic acid template through one cycle of sequencing, and can determine the order of multiple nucleotides/bases on the nucleic acid template through multiple cycles of sequencing. For example, for an SBS-based sequencing platform, the reaction system includes a sequencing primer, a reaction substrate (a nucleotide or an analog thereof), a polymerase, and a nucleic acid template. The nucleic acid template is bound to the sequencing primer. Each cycle of sequencing includes a process of contacting the polymerase and the reaction substrate with the nucleic acid template under a condition suitable for a polymerization reaction to controllably perform a polymerase chain reaction or a base extension reaction, linking or binding or incorporating a nucleotide into the nucleic acid template, and acquiring a corresponding reaction signal. After each cycle of sequencing is completed, the type of nucleotide linked or bound or incorporated to the nucleic acid template is determined on the basis of the reaction signal.

In some examples, each cycle of sequencing may include one or more base extension reactions. For example, a mixture of all the four nucleotides (e.g., A, T, C, and G) can be added to the reaction system to perform the base extension reaction and acquire the corresponding reaction signal, and one cycle of sequencing includes one base extension reaction; combinations of two nucleotides (e.g., A/T and C/G) can also be sequentially added to the reaction system to perform the base extension reactions and acquire the corresponding reaction signals, and one cycle of sequencing includes two base extension reactions; the four nucleotides (e.g., A, T, C, and G) can also be sequentially added to the reaction system to perform the base extension reactions and acquire the corresponding reaction signals, and one cycle of sequencing includes four base extension reactions.

The term “nucleic acid template” refers to a master nucleic acid molecule or master nucleic acid molecule fragment that binds to nucleotides or nucleotide analogs by multiple successive base extension cycles. The nucleic acid template may be the entire sequence of the nucleic acid molecule or a partial fragment of the nucleic acid molecule. The “nucleic acid template” may be a nucleic acid fragment used as a template in extension reactions in which sequencing by synthesis is performed; since the base added to the extension reactions and the sequencing template satisfy the base pairing rules, the sequence of the sequencing template can be determined by determining the type of the base added to each extension cycle. The nucleic acid template may include ribonucleotides, deoxyribonucleotides, analogs thereof, or mixtures thereof. The term may refer to a single-stranded or double-stranded polynucleotide. Nucleotides in a nucleic acid template may include natural nucleotides and functionally alternative analogs thereof. Examples of analogs can hybridize to nucleic acids in a sequence-specific manner, or can be used as templates for the replication of particular nucleotide sequences. Natural nucleotides generally have a backbone containing a phosphodiester bond. Analog structures may have alternative backbone linkages including any types known in the art. Natural nucleotides generally have deoxyribose (e.g., found in DNA) or ribose (e.g., found in RNA). Analog structures may have alternative sugar moieties including any types known in the art. Nucleotides may contain natural bases. Bases in natural DNA may include one or more of adenine, thymine, cytosine, and/or guanine, and bases in natural RNA may include one or more of adenine, uracil, cytosine, and/or guanine. Any non-natural base or base analog may also be contained in a nucleotide, such as a locked nucleic acid (LNA) and a bridged nucleic acid (BNA).

It should be noted that those skilled in the art will appreciate that after each base extension reaction, a corresponding reaction signal can be acquired by a microscopic imaging system and an image can be formed, so as to determine the base type of any designated position on the nucleic acid template on the basis of the image. Correspondingly, the intensity of the reaction signal may be characterized by the “pixel value” or “grayscale value” at a corresponding position in the image where the reaction signal is imaged.

However, when the reaction signal is acquired by the microscopic imaging system, the microscopic imaging system exhibits instability due to external vibration or other influences, and the image formed by the reaction signal acquired by the microscopic imaging system is distorted. In order to perform base calling, the reaction site is located in the distorted image. Compared with locating the reaction site in the undistorted image, the located reaction site may have a position bias, resulting in the inability to extract the signal intensity or grayscale value really corresponding to the reaction site, thereby reducing the base calling accuracy.

In order to solve the above problems, the present application discloses a method for base calling and a method and apparatus for processing image distortion. The method for base calling includes: acquiring an image of interest, where the image of interest is generated by imaging during the sequencing of a nucleic acid template on a surface of a solid substrate; the surface of the solid substrate includes a plurality of reaction sites; the nucleic acid template is located at the reaction sites; determining an initial position of the reaction site in the image of interest; correcting the initial position and determining a desired position of the reaction site in the image of interest to eliminate a position bias of the reaction site in the image of interest; acquiring a grayscale value of the desired position of the reaction site in the image of interest; and identifying, on the basis of the grayscale value, the type of a base incorporated into the nucleic acid template. The above solution can determine the initial position of the reaction site in the image of interest, correct the initial position, and determine the desired position of the reaction site on the image of interest to eliminate the position bias of the reaction site in the image of interest, thereby accurately locating the reaction site in the image of interest and improving the base calling accuracy. The specific implementation is detailed in the following examples.

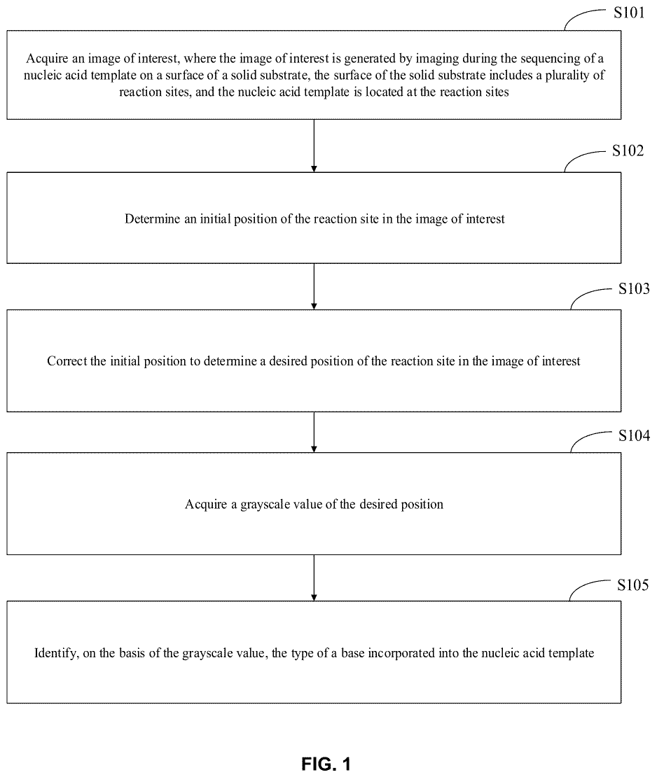

FIG. 1 shows a method for base calling according to Example 1 of the present application. The method mainly includes the following steps:

S101: acquiring an image of interest, where the image of interest is generated by imaging during the sequencing of a nucleic acid template on a surface of a solid substrate, the surface of the solid substrate includes a plurality of reaction sites, and the nucleic acid template is located at the reaction sites.

It should be noted that, the surface of the solid substrate includes marking lines. The marking line may also be referred to as an identification line or a trackline. It mainly serves to facilitate the acquisition of a standard field of view (FOV) and the location of the reaction site, such that the correspondence between the acquisition position and the acquisition signal can be confirmed according to the marking lines during the signal acquisition process. The marking lines include a plurality of first marking lines extending in a first direction and parallel to each other, and a plurality of second marking lines extending in a second direction and parallel to each other; the first direction is non-parallel to the second direction. Preferably, the first direction is perpendicular to the second direction. Illustratively, the first direction may denote the horizontal direction, and the second direction may denote the vertical direction. The plurality of first marking lines and the plurality of second marking lines divide the surface of the solid substrate into a plurality of blocks. The standard FOV may include a preset number (e.g., 4×7) of blocks, and each block includes a number of reaction sites.

In some examples, the marking lines are provided with reaction sites, and the spacing distances between these reaction sites are identical to the spacing distances between reaction sites within the block. The reaction sites in the marking line are mainly used for locating the reaction sites in the block.

S102: determining an initial position of the reaction site in the image of interest.

In S102, determining the initial position of the reaction site in the image of interest includes: determining a position of a preset reference point in an intersection region of the first marking line and the second marking line in the image of interest, and determining the initial position of the reaction site in the image of interest according to the position of the preset reference point in the image of interest. Furthermore, determining the initial position of the reaction site in the image of interest according to the position of the preset reference point in the image of interest includes: determining initial positions of reaction sites in the first marking line and/or the second marking line in the image of interest on the basis of the preset reference point, and determining initial positions of reaction sites within each block in the image of interest on the basis of the initial positions of the reaction sites in the first marking line and/or the second marking line in the image of interest. Illustratively, the preset reference point may be a cross point.

The first marking line may denote a transverse line of a cross point, and the second marking line may denote a longitudinal line of a cross point. The preset reference point is a reference location point for locating reaction sites in the image by the linear interpolation method when locating the reaction sites.

It should be noted that the preset reference point may or may not be a reaction site, which may be designed as desired.

Specifically, the process of determining the initial positions of the reaction site within each block in the image of interest on the basis of the initial positions of the reaction sites in the first marking line and/or the second marking line in the image of interest is as follows:
determining the initial positions of the reaction site within each block in the image of interest according to the uniform linear interpolation method and the positions of the reaction sites in the first marking line and/or the second marking line.

It should be noted that the reaction sites within each block are arranged in an array. The array arrangement includes, but is not limited to, an equilateral triangular arrangement, a quadrangle arrangement, a regular hexagon arrangement, and the like.

The reaction sites in the first marking line and/or the second marking line are linearly arranged (including arranged in a straight line) with at least part of the reaction sites within the block.

The initial positions of the reaction sites in each block in the image of interest refer to the positions of the reaction sites in each block before the image of interest is corrected.

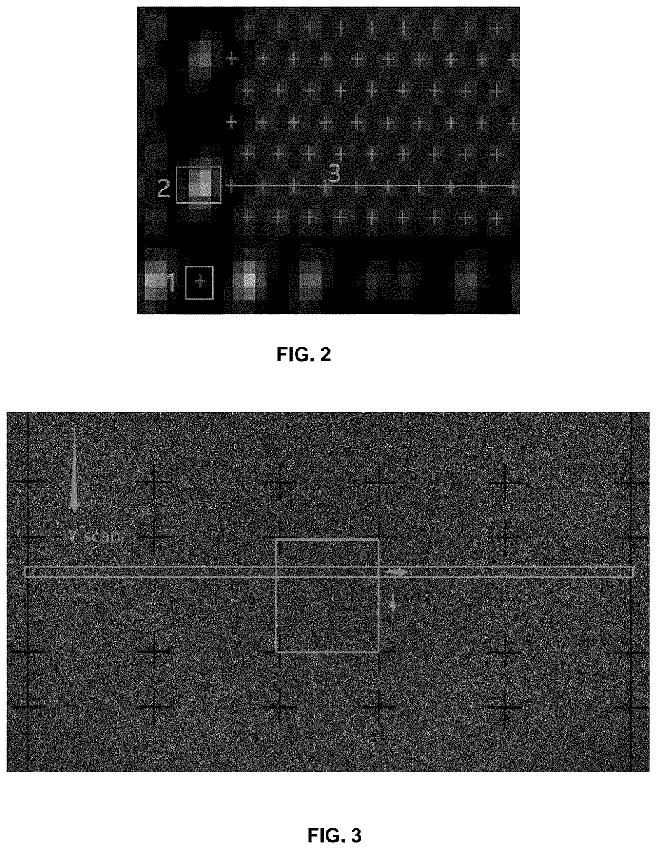

FIG. 2 is a schematic view of the positions of preset reference points in an image of interest.

As shown in FIG. 2, determining the initial position of the reaction site in the image of interest includes: determining the position of the preset reference point in the intersection region of the first marking line and the second marking line, such as the position of the cross point in box 1, then determining the initial positions of the reaction sites in the first marking line and/or the second marking line, such as the initial positions of the reaction sites in box 2, and finally determining the initial positions of the reaction sites in the block (such as the initial positions of those reaction sites on straight line 3) by the linear interpolation method on the basis of the initial positions of the reaction sites in box 2.

The physical distances between adjacent reaction sites are generally designed to be equal. Therefore, when locating the reaction sites, all reaction sites in the image, including the reaction sites in the marking lines and the reaction sites within the block, are located by the linear interpolation method using the preset reference points in the image, i.e., the cross points.

However, as described above, due to the instability of the microscopic imaging system, the image formed by the signals acquired by the microscopic imaging system may be distorted and cannot ensure the consistency in spacing distance between adjacent reaction sites in the image. In this case, a location bias may be caused by using equal spacing distances between the left and right (or upper and lower) preset reference points in the linear interpolation method. In addition, such a bias may be uneven and may have the following characteristics: the farther away from the two preset reference points, the greater the bias. Through the observation of experimental data, it is found that this unequal spacing distance mainly occurs in the Y direction of the image (i.e., the vertical direction in the image), which may be associated with the imaging stability of the microscopic imaging system in this direction.

For example, the lens of the mechanically controlled microscopic imaging system may be unstable in movement, with horizontal or vertical shake, resulting in blurring of the acquired image, changes in magnification, and/or image distortion. Also, in combination with the imaging process and the analysis of the measured data, it is assumed that the biases in the X and Y directions of all reaction sites in the same horizontal direction in the images of different bases are consistent. FIG. 3 is a schematic view illustrating the movement fluctuation of an image in the X and Y directions during imaging. In FIG. 3, the upper-lower direction is the Y direction, which is the moving direction of the solid substrate. The left-right direction is the X direction, which corresponds to the extension direction of the camera acquisition region. Preferably, the camera is a time delay integration line scan camera. The Z direction perpendicular to the XY plane denotes the movement direction of the camera of the microscopic imaging system, in which the distance between the camera and the surface of the solid substrate is adjusted to focus on the surface of the solid substrate, so as to acquire a clear image.

Since the movement fluctuation in the X and Y directions during the imaging process, the spacing distance between the located reaction sites in the image may not be uniform. That is, the spacing distance between the reaction sites is uniform on the object side but not uniform on the image side, which is caused by the instability of the microscopic imaging system. There may be many factors affecting the instability of the microscopic imaging system, such as the vibration generated by the moving camera. The instability of the microscopic imaging system may cause fluctuations in the X, Y, and Z directions, which may cause uneven distribution of spots in the block in the image, and bias in the location of the four preset reference points or cross points. The spot is the representation of a signal in an image.

It should be noted that the block is a rectangular box at the center of the schematic view of movement fluctuation in the X and Y directions, i.e., an area defined by 4 cross points. After the 4 cross points are located, since the number and spacing distance of reaction sites between every two cross points are known, the positions of the reaction sites between every two cross points, i.e., the positions of the reaction sites in the marking lines, can be located by the uniform linear interpolation method. The plurality of reaction sites in the marking line are in one-to-one correspondence with the plurality of reaction site rows in the block, and each reaction site in the marking line may form a linear arrangement with the corresponding reaction site row in the block. As such, after the reaction sites in the marking line are located, the reaction sites in the area within the block may also be located by the uniform linear interpolation method, as the reaction sites within the block are equidistant, and the number of reaction sites in each row is also known.

Due to the instability of the microscopic imaging system, the acquired image may be distorted. More specifically, fluctuations in the X direction may cause left and right translations of the imaging of the microscopic imaging system; fluctuations in the Y direction may cause changes in the magnification of the microscopic imaging system; fluctuations in the Z direction may lead to blurred images. Therefore, in order to solve the problem of uneven spacing distance between adjacent reaction sites when imaging the surface of the solid substrate, a method of correcting the position of the reaction site in the image by calculating the pixel bias value in the Y direction of the image based on a small number of reaction sites is used to improve the base calling accuracy.

S103: correcting the initial position to determine a desired position of the reaction site in the image of interest.

In order to solve the problem of uneven spacing distance between adjacent reaction sites when imaging the surface of the solid substrate, a method of correcting the position of the reaction site in the image by calculating the pixel bias value in the Y direction of the image based on a small number of reaction sites is used to perform accurate base calling. Illustratively, the general process of base calling in the present application includes: inputting an image->locating a preset reference point in the image->locating a reaction site in the image (uniform linear interpolation)->correcting a position of the reaction site->extracting a grayscale value or brightness of the reaction site->correcting the brightness->base calling. The base calling process of the present application differs from conventional base calling processes in that a step of correcting the position of the reaction site is added.

It should be noted that the desired position refers to the position of the reaction site on the image when there is no distortion.

Compared with a conventional process of converting a sequencing signal into a nucleotide base, i.e., the base calling process, the method for base calling of the present application corrects the reaction sites of an image by calculating the bias of the reaction sites at different positions of the image in the vertical direction (Y direction), thereby improving the base calling accuracy.

The base calling is to identify the type of base incorporated into the nucleic acid template at the reaction site corresponding to each spot in the image of interest. The image of interest is similar to the above schematic view of movement fluctuation in the X and Y directions, and each spot corresponds to a signal generated by one reaction site on the surface of the solid substrate. Illustratively, the signal may be emitted from a fluorophore carried by a nucleotide. Depending on the type of fluorophore carried by the nucleotide incorporated into the nucleic acid template, a spot of the corresponding color is acquired. Illustratively, during one cycle of sequencing, four nucleotides carrying different fluorophores (i.e., four bases A, T, C, and G) are simultaneously added to participate in the base extension reaction, and imaging is performed by using a multi-channel microscopic imaging system, such that four images are acquired, including an image containing a fluorescence signal (red spot) generated by base A, an image of a fluorescence signal (blue spot) generated by base T, an image of a fluorescence signal (green spot) generated by base C, and an image of a fluorescence signal (yellow spot) generated by base G. By performing the analysis according to the above base calling procedures, the type of base incorporated at a designated reaction site can be determined. As such, the base sequence of the nucleic acid template can be acquired by performing multiple cycles of sequencing.

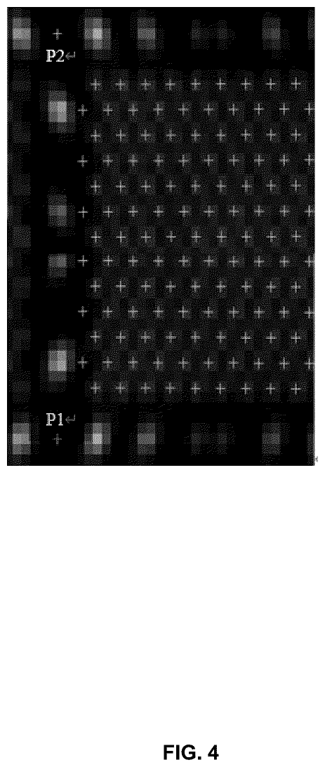

The cross points and reaction sites are shown in FIG. 4. FIG. 4 illustrates a schematic view of the marking of cross points and reaction sites.

In FIG. 4, after the reaction sites are located to give the initial positions of the reaction sites, the initial positions of the reaction sites are corrected to determine the desired positions.

The correction of the initial positions of the reaction sites mainly includes the following procedures: locating reaction sites in a marking line (including the first marking line and/or the second marking line), and calculating the bias of the reaction sites in each region and the scoring function for reaction site location accuracy one by one.

Locating reaction sites in a marking line:

By using two (upper and lower) cross points (preset reference points), the position coordinates of the reaction sites in the marking line between the two cross points are calculated by linear interpolation.

Assuming that the coordinates of the upper and lower cross points P1 and P2 are P₁(x₁, y₁) and P₂(x₂, y₂), respectively, and N reaction sites are present between the two cross points P1 and P2 (if P1 and P2 are reaction sites, the N reaction sites include P1 and P2), the coordinate of the i^{th} reaction site is Pi(x₁+i*(x₂−x₁)/(N−1), y₁+i*(y₂−y₁)/(N−1)). According to the Y-direction coordinates in the image, each block in the image is evenly divided into N parts from top to bottom, and each part corresponds to some of the reaction sites in the image, including the reaction sites in the marking line.

The specific process of correcting the initial position to determine a desired position of the reaction site in the image of interest is shown in A1-A4.

A1: dividing each block in the image of interest into N sub-regions.

Each sub-region includes at least one reaction site in the first marking line and/or the second marking line.

N is a natural number greater than or equal to 1.

A2: moving the reaction sites in the first marking line and/or the second marking line in the sub-region in the first direction and/or the second direction to correct the initial positions of the reaction sites in the first marking line and/or the second marking line in the image of interest, so as to acquire desired positions of the reaction sites in the first marking line and/or the second marking line in the image of interest.

A3: determining a movement amount of the reaction sites in the first marking line and/or the second marking line from the initial positions to the desired positions.

The specific process of determining a movement amount of the reaction sites in the first marking line and/or the second marking line from the initial positions to the desired positions is shown in B1-B3.

B1: correcting, after each movement of the reaction sites in the first marking line and/or the second marking line in the sub-region, the remaining reaction sites in the sub-region by the movement amount of the movement.

B2: evaluating the accuracy of the positions of the remaining reaction sites in the corrected sub-region.

Specifically, on all reaction sites in the marking line in the i^{th} region in the ACGT four-base image, translation attempts in the X and Y directions are performed. In each translation, a scoring function is used to evaluate the locating accuracy of the reaction sites, and a higher score indicates higher location accuracy. The optimal bias value is determined by the X-direction and Y-direction bias values with the highest score.

B3: determining the movement amount of the reaction sites in the first marking line and/or the second marking line from the initial positions to the desired positions according to the evaluation result.

The movement amount of moving the reaction sites in the first marking line and/or the second marking line from the initial positions to the desired positions in the i+1^{th} sub-region of the N sub-regions is determined by using the movement amount of moving the reaction sites in the first marking line and/or the second marking line from the initial positions to the desired positions in the i^{th} sub-region of the N sub-regions. i is a non-zero natural number <N.

The specific process of determining the movement amount of moving the reaction sites in the first marking line and/or the second marking line from the initial positions to the desired positions in the i+1^{th} sub-region of the N sub-regions by using the movement amount of moving the reaction sites in the first marking line and/or the second marking line from the initial positions to the desired positions in the i^{th} sub-region of the N sub-regions is shown in C1-C3.

C1: traversing within a preset movement range according to a preset step length on the basis of the movement amount of the reaction sites in the first marking line and/or the second marking line in the i^{th} sub-region from the initial position to the desired position in the i^{th} sub-region.

In order to simplify the calculation and improve the calculation accuracy, for the i+1 sub-regions, the bias value calculated for i sub-regions is used as the basic bias (i.e., the movement amount of moving the reaction sites in the first marking line and/or the second marking line from the initial positions to the desired positions in the i^{th} sub-region of the N sub-regions), and on this basis, the optimal bias value (i.e., movement amount of moving the reaction sites in the first marking line and/or the second marking line from the initial positions to the desired positions in the i+1^{th} sub-region of the N sub-regions) is calculated.

First, assuming that the optimal pixel bias values of reaction sites in the i sub-regions are xᵢ, yᵢ, for region i+1, traversing is performed with a preset step size, such as a step size of xstep, ystep, within a bias value range [xᵢ−dx, xᵢ+dx], [yᵢ−dy, yᵢ+dy], and each bias value plus the coordinates of the reaction site in region i+1 is taken as the attempt coordinates.

Then, a scoring function for point location accuracy is used for scoring, and the bias corresponding to the highest score is taken as the final bias of region i+1; xstep, ystep, dx, and dy are empirical parameters, and the specific values depend on the degree of image bias and the algorithm strategy; an excessive value may increase the computational complexity, while an insufficient value may fail to give an accurate value. The bias of a total of N regions from top to bottom is sequentially calculated as such.

Finally, the bias values of the N regions calculated from the reaction sites in the marking line are acquired; for the reaction sites in each region, the bias values in the X and Y directions are added to the x and y coordinate positions as the corrected coordinates.

It should be noted that since the bias values have continuity, adjacent bias values are similar, and the previous bias value may be used as a starting value for calculating the next bias value.

C2: correcting the remaining reaction sites in the i+1^{th} sub-region by the movement amount of each movement, and evaluating the accuracy of the positions of the remaining reaction sites in the corrected i+1^{th} sub-region.

The accuracy of the positions of the remaining reaction sites in the corrected i+1^{th} sub-region is evaluated, i.e., through the scoring function for reaction site location accuracy. It is assumed that there are a total of N reaction sites in one region, the scoring function is a sum of signal brightness dispersion coefficients of the four ACGT images, and the calculation formula of the scoring function is shown in formula (1).

$$Score = {\sum }_{colo rs} \frac{\sqrt{\frac{{\sum }_{i}^{N} {( {x}_{i} - \overline{x} )}^{2}}{N - 1}}}{\overline{x}} \qquad ( 1 )$$

In the formula, Score is the score; xᵢ is the signal brightness corresponding to the 7^{th} reaction site; x̅ is the mean brightness of the signals corresponding to the N reaction sites; and colors is the sum of signal brightness dispersion coefficients of the four ACGT base images. The main reason for using the sum of the four base images instead of a monochrome image is to enhance the stability of the algorithm. In general, a more accurate reaction site location may result in greater dispersion coefficients and a higher score.

C3: determining the movement amount of the reaction sites in the first marking line and/or the second marking line from the initial positions to the desired positions according to the evaluation result.

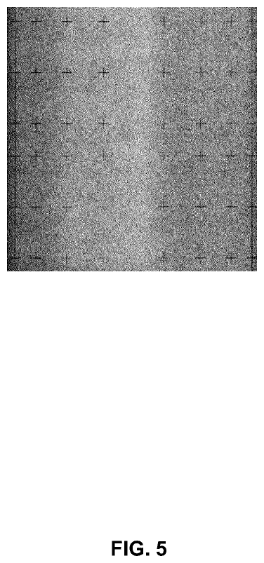

In order to verify the effectiveness of correcting the initial positions of the reaction sites in the image of interest, the image of interest used in this example is shown in FIG. 5.

In FIG. 5, the image includes 6×8 cross points, and an image area defined by every four cross points is referred to as one block. The image includes a total of 35 (5×7) blocks, and the widths and heights (pixels) of blocks in different areas of the image are symmetrical in the upper-lower and left-right directions.

The image data was input into a conventional base calling process and the base calling process described above in the present application to output sequence file data, and then the mapping rate and mismatch rate of base calling were summarized through multi-sequence alignment. Meanwhile, the sequence quality assessment standard (Q30), mapping rate, and mismatch rate commonly used in gene detection were compared to demonstrate the effectiveness of correction.

In one example, the process of correcting the initial positions of the reaction sites in the image of interest is generally as follows:

First, in order to calculate the bias values in different regions of the image, five rows of blocks were evenly divided into 25, 25, 20, 25, and 25 regions from top to bottom in the Y direction of the image.

Then, the optimal bias value of each region in each block was calculated from top to bottom according to the method described in C1-C3 above. The parameters are dx=−0.1, dy=0.3, xstep=0.1, and ystep=0.1 (unit: pixel). xstep, ystep, dx, and dy are empirical parameters, and their values are in the sub-pixel range. The specific values depend on the image size, the maximum bias degree of pixels, and the algorithm strategy. An excessive value may increase the computational complexity and reduce the stability of the algorithm, while an insufficient value may fail to give an accurate value.

Finally, for the reaction sites in each region in each block, a corresponding optimal bias value was used to correct the positions of the reaction sites.

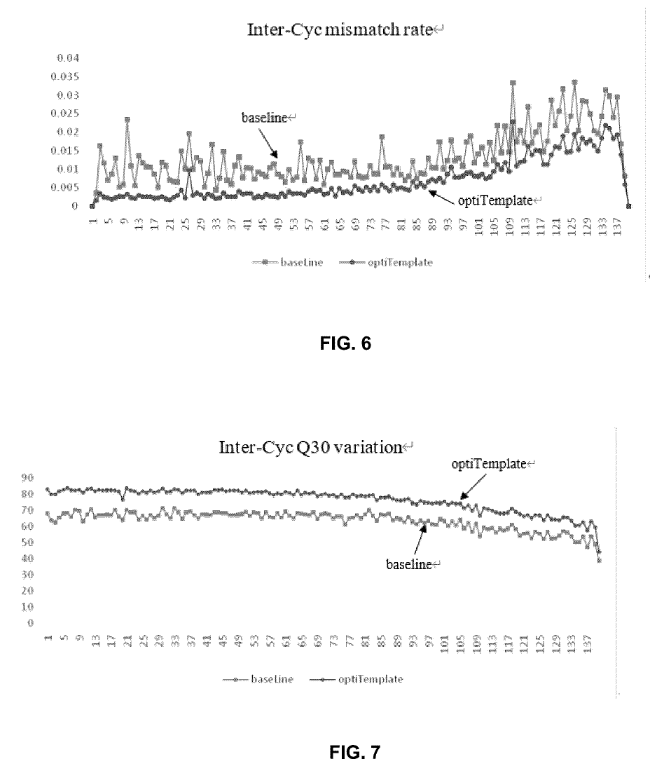

After performing a conventional base calling and a base calling with reaction site correction using the image data acquired by sequencing, the acquired sequences were further subjected to multi-sequence alignment, and Q30, mapping rate and mismatch rate were summarized. Details are shown in Table 1 and FIGS. 6 and 7. In FIGS. 6 and 7, baseLine denotes the conventional base calling process, and optiTemplate denotes the base calling process with reaction site position correction of the present application.

TABLE 1
Result comparison

| Base calling method | Q30 | MappingRate | MismatchRate |
|---|---|---|---|
| baseLine | 63.49% | 71.50% | 1.36% |
| optiTemplate | 76.37% | 88.06% | 0.52% |

Generally, when the base calling process including reaction site correction of the present application was used, the base calling result was significantly improved: the Q30 was increased by 12.88%, the mapping rate was increased by 16.56%, and the mismatch rate was decreased by 0.84%.

In addition, as the sequencing cycles (or Cyc) progressed, it can be seen that the use of the base calling process including reaction site correction of the present application exhibited two advantages, i.e., better overall results and higher inter-Cyc stability.

These two facts indicate that the use of the base calling process including reaction site position correction of the present application can significantly eliminate the problem of uneven spacing distances among reaction sites during the imaging, and make the reaction site location more accurate, thereby significantly improving the sequencing accuracy and reducing the mismatch rate.

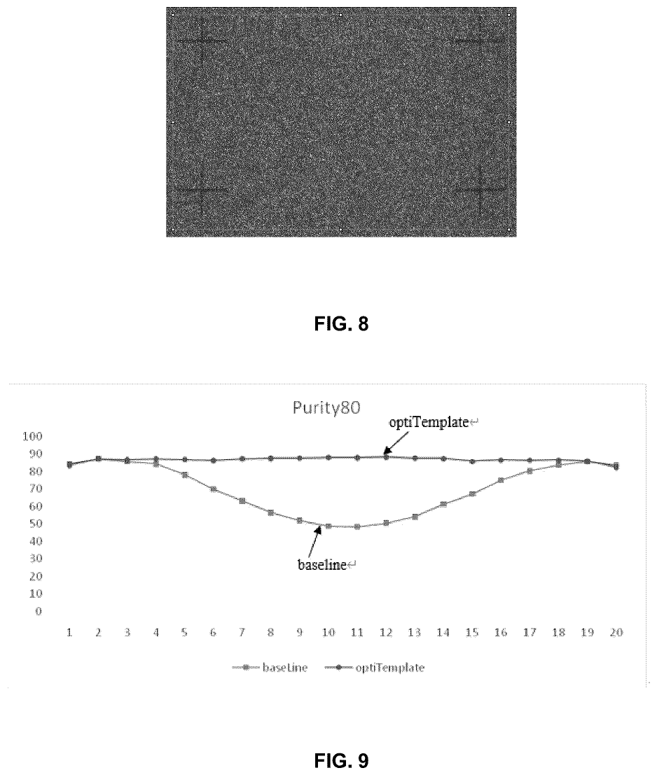

In order to visually demonstrate the effect of using the method for base calling of the present application, a specific example is provided herein with FIG. 8.

In the regions defined by 4 cross points in FIG. 8, the grayscale values or brightness values corresponding to the reaction sites were extracted using the base calling process without/with reaction site position correction. The image was evenly divided into 20 parts in the Y direction of the image, and the proportion of reaction sites in each region with a brightness purity greater than 80% (denoted as purity 80) was calculated, where the definition of the brightness purity is shown in formula (2).

$$purity = 100 * ( 1 - \frac{sec Ints}{max Ints} ) \qquad ( 2 )$$

In the formula, purity is the brightness purity; maxInts is the maximum base brightness of signals corresponding to the same reaction site in different images in one cycle of sequencing; secInt is the second greatest base brightness of signals corresponding to the same reaction site in different images in one cycle of sequencing. Generally, a more accurate reaction site location may result in a greater resolution of high-brightness bases and low-brightness bases in the same reaction site and thus a higher brightness purity. The optimization results in the Y direction of the image are shown in FIG. 9.

As can be seen from FIG. 9, when only linear interpolation location is used without reaction site position correction, reaction sites closer to the upper and lower cross points exhibited higher brightness purities, while those closer to the center exhibited lower brightness purities. This indicates that the spacing distances among reaction sites in the image are not uniform, resulting in a cumulative error of reaction site bias when the linear interpolation is used. However, the base calling process using the reaction site position correction can accurately correct this error, such that all reaction sites in the image are accurately located, and the brightness purity of each region is the highest (optimal).

A4: correcting the remaining reaction sites in the sub-region based on the movement amount to determine desired positions of the remaining reaction sites in the sub-region in the image of interest.

S104: acquiring a grayscale value of the desired position.

It should be noted that, the grayscale value is the brightness value.

S105: identifying, on the basis of the grayscale value, the type of a base incorporated into the nucleic acid template.

In S105, the grayscale value of the desired position of the reaction site in the image of interest is corrected, and the type of base incorporated into the nucleic acid template is identified by using the corrected grayscale value; that is, the type of base incorporated into the nucleic acid template is identified by using brightness correction.

Correcting the grayscale value of the desired position of the reaction site in the image of interest at least includes one or more of bleeding correction, crosstalk correction, phasing/prephasing correction, and normalization correction.

The brightness correction is performed by bleeding correction, crosstalk correction, phasing/prephasing correction, and normalization correction.

### Bleeding Correction:

A “bleeding” of brightness signal may be present between adjacent clusters in an image, and a spatial distribution of cluster brightness may be present with the cluster as the center, resulting in superposition of brightness between adjacent clusters. For a cluster signal, in order to eliminate such superposition of brightness, the sum of ambient brightness is subtracted according to a certain proportion. The “cluster” refers to a plurality of amplicons formed after the amplification of the nucleic acid template at the reaction site. The formation of the plurality of amplicons can amplify the reaction signal during the sequencing process, facilitating the identification of the reaction signal.

The specific expression of bleeding correction is shown in formula (3).

$$Intsbleed ( i ) = IntsR ( i ) - bld * {\sum }_{j ∈ {N}_{i}} IntsR ( j ) \qquad ( 3 )$$

In the formula, Intsbleed(i) is a signal subjected to bleeding correction; IntsR(i) is an original signal of a central cluster; bld is an empirical parameter; Nᵢ is a set of all spatial neighboring cluster points of cluster i; and IntsR(j) is the signal intensity of a neighboring cluster.

### Crosstalk Correction:

Crosstalk correction refers to a crosstalk correction between the brightnesses of the four bases ACGT. Since optical absorption spectra of the signals of the four bases ACGT may overlap in wavelength (frequency), crosstalk may occur between the brightnesses of the ACGT. For example, the brightnesses of A signals in the same cluster may disturb T signals in a specific proportion to form the crosstalk. Therefore, for signals of various bases, the part from the crosstalk of other bases should be subtracted. An exemplary crosstalk correction using the base A signal is provided, and the expression of the exemplary crosstalk correction using the base A signal is shown in formula (4).

$$IntsACross = IntsA - {\sum }_{B ∈ \{ G , C , T \}} {k}_{BA} Ints B \qquad ( 4 )$$

In the formula, IntsACross is the signal of base A subjected to crosstalk correction; IntsA is the original signal of base A; B is the signal of base G, C, or T; k_{BA} is the signal proportion of crosstalk from base B to base A; for two determined bases (i.e., base A and base B), the proportion of crosstalk between signals is generally a constant, and its value depends on the wavelength absorption spectrum and the optical system of the signals of bases ACGT; the constant can be calibrated by means of a real image; Ints B is the original signal of base B.

### Phasing/Prephasing Correction:

Generally, the phase error is represented by phasing (phase) or prephasing (prephase). The phasing refers to that the nucleotide that should be incorporated into the nucleic acid template in cycle K but participates in the reaction in cycle K+1. The prephasing refers to that the nucleotide that should be incorporated into the nucleic acid template in cycle K but participates in the reaction in Cycle K−1. That is, there will be crosstalk between adjacent cycles in the same channel. Such phase errors may continuously accumulate and become stronger as the number of sequencing cycles increases. Therefore, during the sequencing process, the phasing/prephasing correction is required. Illustratively, in the phasing/prephasing correction process, for example, for an A signal in the i^{th} cycle, the crosstalk part to the i+1^{th} cycle and the i−1^{th} cycle should be added back in a specific proportion, and the part from previous and next cycle should be subtracted in a specific proportion (that is, the crosstalk part from the previous and next cycles to the current cycle). The proportion of the crosstalk signal is usually calculated in real time by an algorithm.

### Normalization Correction:

The signal intensities of ACGT may be at different levels. After proper normalization correction, the signals of the four bases may be directly compared. The signals may be normalized by using the maximum-minimum normalization method. The specific expression of normalization correction is shown in formula (5).

$$int s ( i ) = \frac{int s ( i ) - min Ints}{max Ints - min Ints} * 7500 \qquad ( 5 )$$

In the formula, Ints′(i) refers to the signal intensity after correction of the signal corresponding to the i^{th} reaction site in a certain cycle of sequencing reaction, Ints (i) refers to the signal intensity before correction of the signal corresponding to the i^{th} reaction site in a certain cycle of sequencing reaction, minInts refers to the minimum signal intensity among all reaction sites in a certain image in a certain cycle of sequencing reaction, and maxInts refers to the maximum signal intensity among all reaction sites in a certain image in a certain cycle of sequencing reaction.

Example 1 of the present application has the following beneficial effects: By determining the initial position of the reaction site in the image of interest, correcting the initial position, and determining the desired position of the reaction site on the image of interest to eliminate the position bias of the reaction site in the image of interest due to unequal spacing distances, all the reaction sites in the image of interest are accurately located, the brightness purity of each position is optimized, and the accuracy of base calling is improved.

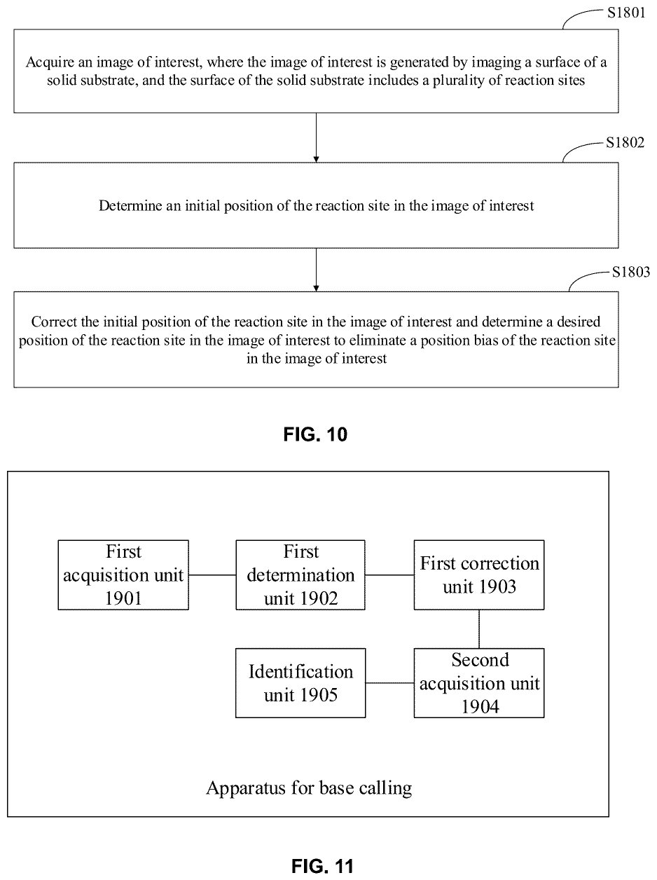

FIG. 10 shows the method for processing image distortion according to Example II of the present application. The method for processing image distortion mainly includes the following steps:

S1801: acquiring an image of interest, where the image of interest is generated by imaging a surface of a solid substrate, and the surface of the solid substrate includes a plurality of reaction sites.

It should be noted that the surface of the solid substrate includes a plurality of first marking lines extending in a first direction and parallel to each other, and a plurality of second marking lines extending in a second direction and parallel to each other; the first direction is non-parallel to the second direction. The first direction is perpendicular to the second direction.

S1802: determining an initial position of the reaction site in the image of interest.

In S1802, a position of a preset reference point in an intersection region of the first marking line and the second marking line in the image of interest is determined, and the initial position of the reaction site in the image of interest according to the position of the preset reference point in the image of interest is determined.

The plurality of first marking lines and the plurality of second marking lines divide the surface of the solid substrate into a plurality of blocks. Initial positions of reaction sites in the first marking line and/or the second marking line in the image of interest on the basis of the preset reference point are determined, and initial positions of reaction sites within each block in the image of interest are determined on the basis of the initial positions of the reaction sites in the first marking line and/or the second marking line in the image of interest.

The reaction sites within each block are arranged in an array; the reaction sites in the first marking line and/or the second marking line are arranged in a straight line with at least part of the reaction sites within the block.

Specifically, the process of determining the initial positions of the reaction site within each block in the image of interest on the basis of the initial positions of the reaction sites in the first marking line and/or the second marking line in the image of interest is as follows:
determining the initial positions of the reaction site within each block in the image of interest according to the uniform linear interpolation method and the positions of the reaction sites in the first marking line and/or the second marking line.

S1803: correcting the initial position of the reaction site in the image of interest and determining a desired position of the reaction site in the image of interest to eliminate a position bias of the reaction site in the image of interest.

Specifically, the process of correcting the initial position of the reaction site in the image of interest and determining a desired position of the reaction site in the image of interest to eliminate a position bias of the reaction site in the image of interest is shown in D1-D4.

D1: dividing each block in the image of interest into N sub-regions, where each sub-region includes at least one reaction site in the first marking line and/or the second marking line. N is a natural number greater than or equal to 1.

D2: moving the reaction sites in the first marking line and/or the second marking line in the sub-region in the first direction and/or the second direction to correct the initial positions of the reaction sites in the first marking line and/or the second marking line in the image of interest, so as to acquire desired positions of the reaction sites in the first marking line and/or the second marking line in the image of interest.

D3: determining a movement amount of the reaction sites in the first marking line and/or the second marking line from the initial positions to the desired positions.

In D3, after each movement of the reaction sites in the first marking line and/or the second marking line in the sub-region, the remaining reaction sites in the sub-region are corrected by the movement amount of the movement, and the accuracy of the positions of the remaining reaction sites in the corrected sub-region is evaluated; the movement amount of the reaction sites in the first marking line and/or the second marking line from the initial positions to the desired positions is determined according to the evaluation result.

The specific process of determining a movement amount of the reaction sites in the first marking line and/or the second marking line from the initial positions to the desired positions is as follows:

The movement amount of moving the reaction sites in the first marking line and/or the second marking line from the initial positions to the desired positions in the i+1^{th} sub-region of the N sub-regions is determined by using the movement amount of moving the reaction sites in the first marking line and/or the second marking line from the initial positions to the desired positions in the i^{th} sub-region of the N sub-regions. i is a non-zero natural number <N.

The process of determining the movement amount of moving the reaction sites in the first marking line and/or the second marking line from the initial positions to the desired positions in the i+1^{th} sub-region of the N sub-regions by using the movement amount of moving the reaction sites in the first marking line and/or the second marking line from the initial positions to the desired positions in the i^{th} sub-region of the N sub-regions is shown in E1-E3.

E1: traversing within a preset movement range according to a preset step length on the basis of the movement amount of the reaction sites in the first marking line and/or the second marking line in the i^{th} sub-region from the initial position to the desired position in the i^{th} sub-region;
E2: correcting the remaining reaction sites in the i+1^{th} sub-region by the movement amount of each movement, and evaluating the accuracy of the positions of the remaining reaction sites in the corrected i+1^{th} sub-region; and
E3: determining the movement amount of the reaction sites in the first marking line and/or the second marking line from the initial positions to the desired positions according to the evaluation result.

D4: correcting the remaining reaction sites in the sub-region based on the movement amount and determining desired positions of the remaining reaction sites in the sub-region in the image of interest to eliminate the position bias of the reaction site in the image of interest.

The process and principle for implementing S1801-S1803 are consistent with those for implementing S101-S103 in FIG. 1 in the above example, which will not be recited hereinafter.

Example II of the present application has the following beneficial effects: By determining the initial position of the reaction site in the image of interest, correcting the initial position, and determining the desired position of the reaction site on the image of interest to eliminate the position bias of the reaction site in the image of interest due to unequal spacing distances, all the reaction sites in the image of interest are accurately located, the brightness purity of each position is optimized, and the accuracy of base calling is improved.

On the basis of the method for base calling disclosed in FIG. 1 of the above example, Example III of the present application further correspondingly discloses an apparatus for base calling. As shown in FIG. 11, the apparatus for base calling includes:
a first acquisition unit 1901, configured for acquiring an image of interest, where the image of interest is generated by imaging during the sequencing of a nucleic acid template on a surface of a solid substrate, the surface of the solid substrate includes a plurality of reaction sites, and the nucleic acid template is located at the reaction sites;
a first determination unit 1902, configured for determining an initial position of the reaction site in the image of interest;
a first correction unit 1903, configured for correcting the initial position to determine a desired position of the reaction site in the image of interest;
a second acquisition unit 1904, configured for acquiring a grayscale value of the desired position of the reaction site in the image of interest; and
an identification unit 1905, configured for identifying, on the basis of the grayscale value, the type of a base incorporated into the nucleic acid template.

Furthermore, the identification unit 1905 includes:
a first correction module, configured for correcting the grayscale value of the desired position of the reaction site in the image of interest; and
a first identification module, configured for identifying the type of the base incorporated into the nucleic acid template by using the corrected grayscale values.

Furthermore, correcting the grayscale value of the desired position of the reaction site in the image of interest at least includes one or more of bleeding correction, crosstalk correction, phasing/prephasing correction, and normalization correction.

Furthermore, the surface of the solid substrate includes a plurality of first marking lines extending in a first direction and parallel to each other, and a plurality of second marking lines extending in a second direction and parallel to each other; the first direction is non-parallel to the second direction.

Furthermore, the first direction is perpendicular to the second direction.

Furthermore, the first determination unit 1902 includes:
a first determination module, configured for determining a position of a preset reference point in an intersection region of the first marking line and the second marking line in the image of interest; and
a second determination module, configured for determining the initial position of the reaction site in the image of interest according to the position of the preset reference point in the image of interest.

Furthermore, the plurality of first marking lines and the plurality of second marking lines divide the surface of the solid substrate into a plurality of blocks, and the first determination unit 1902 is specifically configured for determining initial positions of reaction sites in the first marking line and/or the second marking line in the image of interest on the basis of the preset reference point, and determining initial positions of reaction sites within each block in the image of interest on the basis of the initial positions of the reaction sites in the first marking line and/or the second marking line in the image of interest.

Furthermore, the reaction sites within each block are arranged in an array; the reaction sites in the first marking line and/or the second marking line are arranged in a straight line with at least part of the reaction sites within the block.

Furthermore, the first determination unit 1902 configured for determining initial positions of reaction sites within each block in the image of interest on the basis of the initial positions of the reaction sites in the first marking line and/or the second marking line in the image of interest is further specifically configured for determining the initial positions of the reaction site within each block in the image of interest according to the uniform linear interpolation method and the positions of the reaction sites in the first marking line and/or the second marking line.

Furthermore, the first correction unit 1903 includes:
a first division module, configured for dividing each block in the image of interest into N sub-regions, where each sub-region includes at least one reaction site in the first marking line and/or the second marking line;
a second correction module, configured for moving the reaction sites in the first marking line and/or the second marking line in the sub-region in the first direction and/or the second direction to correct the initial positions of the reaction sites in the first marking line and/or the second marking line in the image of interest, so as to acquire desired positions of the reaction sites in the first marking line and/or the second marking line in the image of interest;
a third determination module, configured for determining a movement amount of the reaction sites in the first marking line and/or the second marking line from the initial positions to the desired positions; and
a third correction module, configured for correcting the remaining reaction sites in the sub-region based on the movement amount to determine desired positions of the remaining reaction sites in the sub-region in the image of interest, where N is a natural number greater than or equal to 1.

Furthermore, the third determination module includes:
a first correction sub-module, configured for correcting, after each movement of the reaction sites in the first marking line and/or the second marking line in the sub-region, the remaining reaction sites in the sub-region by the movement amount of the movement, and evaluating the accuracy of the positions of the remaining reaction sites in the corrected sub-region; and
a second movement sub-module, configured for determining the movement amount of the reaction sites in the first marking line and/or the second marking line from the initial positions to the desired positions according to the evaluation result.

Furthermore, the third determination module is specifically configured for determining a movement amount of moving the reaction sites in the first marking line and/or the second marking line from the initial positions to the desired positions in the i+1^{th} sub-region of the N sub-regions by using a movement amount of moving the reaction sites in the first marking line and/or the second marking line from the initial positions to the desired positions in the i^{th} sub-region of the N sub-regions, where i is a non-zero natural number <N.

Furthermore, the third determination module further includes:
a first movement correction sub-module, configured for traversing within a preset movement range according to a preset step length on the basis of the movement amount of the reaction sites in the first marking line and/or the second marking line in the i^{th} sub-region from the initial position to the desired position in the i^{th} sub-region, and correcting the remaining reaction sites in the i+1^{th} sub-region by the movement amount of each movement, and evaluating the accuracy of the positions of the remaining reaction sites in the corrected i+1^{th} sub-region; and
a first determination sub-module, configured for determining the movement amount of the reaction sites in the first marking line and/or the second marking line from the initial positions to the desired positions according to the evaluation result.

Example III of the present application has the following beneficial effects: By determining the initial position of the reaction site in the image of interest, correcting the initial position, and determining the desired position of the reaction site on the image of interest to eliminate the position bias of the reaction site in the image of interest due to unequal spacing distances, all the reaction sites in the image of interest are accurately located, the brightness purity of each position is optimized, and the accuracy of base calling is improved.

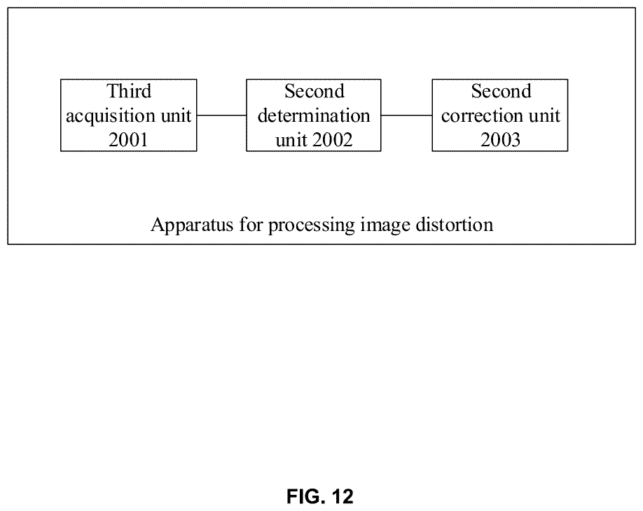

On the basis of the method for processing image distortion disclosed in FIG. 9 in the above example, Example IV of the present application further correspondingly discloses an apparatus for processing image distortion. As shown in FIG. 12, the apparatus for processing image distortion includes:
a third acquisition unit 2001, configured for acquiring an image of interest, where the image of interest is generated by imaging a surface of a solid substrate, and the surface of the solid substrate includes a plurality of reaction sites;
a second determination unit 2002, configured for determining an initial position of the reaction site in the image of interest; and
a second correction unit 2003, configured for correcting the initial position of the reaction site in the image of interest and determining a desired position of the reaction site in the image of interest to eliminate a position bias of the reaction site in the image of interest.

Furthermore, the surface of the solid substrate includes a plurality of first marking lines extending in a first direction and parallel to each other, and a plurality of second marking lines extending in a second direction and parallel to each other; the first direction is non-parallel to the second direction.

Furthermore, the first direction is perpendicular to the second direction.

Furthermore, the second determination unit 2002 includes:
a fourth determination module, configured for determining a position of a preset reference point in an intersection region of the first marking line and the second marking line in the image of interest; and
a fifth determination module, configured for determining the initial position of the reaction site in the image of interest according to the position of the preset reference point in the image of interest.

Furthermore, the plurality of first marking lines and the plurality of second marking lines divide the surface of the solid substrate into a plurality of blocks, and the second determination unit 2002 is specifically configured for determining initial positions of reaction sites in the first marking line and/or the second marking line in the image of interest on the basis of the preset reference point, and determining initial positions of reaction sites within each block in the image of interest on the basis of the initial positions of the reaction sites in the first marking line and/or the second marking line in the image of interest.

Furthermore, the reaction sites within each block are arranged in an array; the reaction sites in the first marking line and/or the second marking line are arranged in a straight line with at least part of the reaction sites within the block.

Furthermore, the second determination unit 2002 configured for determining initial positions of reaction sites within each block in the image of interest on the basis of the initial positions of the reaction sites in the first marking line and/or the second marking line in the image of interest is further specifically configured for determining the initial positions of the reaction site within each block in the image of interest according to the uniform linear interpolation method and the positions of the reaction sites in the first marking line and/or the second marking line.

Furthermore, the second correction unit 2003 includes:
a second division module, configured for dividing each block in the image of interest into N sub-regions, where each sub-region includes at least one reaction site in the first marking line and/or the second marking line;
a fourth correction module, configured for moving the reaction sites in the first marking line and/or the second marking line in the sub-region in the first direction and/or the second direction to correct the initial positions of the reaction sites in the first marking line and/or the second marking line in the image of interest, so as to acquire desired positions of the reaction sites in the first marking line and/or the second marking line in the image of interest;
a fourth determination module, configured for determining a movement amount of the reaction sites in the first marking line and/or the second marking line from the initial positions to the desired positions; and
a fifth determination module, configured for correcting the remaining reaction sites in the sub-region based on the movement amount and determining desired positions of the remaining reaction sites in the sub-region in the image of interest to eliminate the position bias of the reaction site in the image of interest, where N is a natural number greater than or equal to 1.

Furthermore, the fourth determination module includes:
a second movement correction sub-module, configured for correcting, after each movement of the reaction sites in the first marking line and/or the second marking line in the sub-region, the remaining reaction sites in the sub-region by the movement amount of the movement, and evaluating the accuracy of the positions of the remaining reaction sites in the corrected sub-region; and
a second determination sub-module, configured for determining the movement amount of the reaction sites in the first marking line and/or the second marking line from the initial positions to the desired positions according to the evaluation result.

Furthermore, the fourth determination module is specifically configured for determining a movement amount of moving the reaction sites in the first marking line and/or the second marking line from the initial positions to the desired positions in the i+1^{th} sub-region of the N sub-regions by using a movement amount of moving the reaction sites in the first marking line and/or the second marking line from the initial positions to the desired positions in the i^{th} sub-region of the N sub-regions, where i is a non-zero natural number <N.

Furthermore, the fourth determination module further includes:
a second movement sub-module, configured for traversing within a preset movement range according to a preset step length on the basis of the movement amount of the reaction sites in the first marking line and/or the second marking line in the i^{th} sub-region from the initial position to the desired position in the i^{th} sub-region, and correcting the remaining reaction sites in the i+1^{th} sub-region by the movement amount of each movement, and evaluating the accuracy of the positions of the remaining reaction sites in the corrected i+1^{th} sub-region; and
a third movement sub-module, configured for determining the movement amount of the reaction sites in the first marking line and/or the second marking line from the initial positions to the desired positions according to the evaluation result.

Example III of the present application has the following beneficial effects: By determining the initial position of the reaction site in the image of interest, correcting the initial position, and determining the desired position of the reaction site on the image of interest to eliminate the position bias of the reaction site in the image of interest due to unequal spacing distances, all the reaction sites in the image of interest are accurately located, the brightness purity of each position is optimized, and the accuracy of base calling is improved.

One example of the present application further provides a storage medium, including a stored instruction, where the instruction, when executed, controls a device having the storage medium thereon to implement the method for base calling and the method for processing image distortion described above.

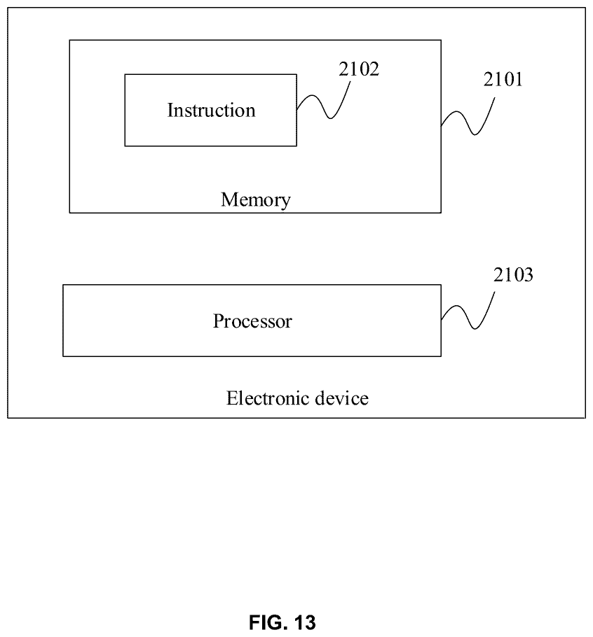

One example of the present application further provides an electronic device, with its schematic view being shown in FIG. 13, specifically including a memory 2101 and one or more instructions 2102, where the one or more instructions 2102 are stored in the memory 2101 and configured for being executed by one or more processors 2103 to implement the method for base calling and the method for processing image distortion described above.

For brevity, the above method examples are described as a series of action combinations. However, those skilled in the art will appreciate that the present application is not limited to the described order of the actions, since according to the present application, some procedures may be performed in other orders or simultaneously. Secondly, those skilled in the art will also appreciate that the examples described in the specification are preferred examples, and the involved actions and modules are not necessary to the present application.

It should be noted that in the specification, the examples are described in a progressive manner. The examples focus on their differences from other examples, and reference can be made among other examples for the same and similar parts. The system examples are substantially similar to the method examples, and therefore are described briefly. For related parts, reference can be made to the descriptions in the method examples.

The procedures in the methods in the examples of the present application may be adjusted, combined, or deleted as desired.

Finally, it should be noted that relational terms such as first and second herein are only used to distinguish one entity or procedure from another entity or procedure, and do not necessarily require or imply any such actual relationship or order between these entities or procedures.

The above description of the disclosed examples is provided to enable those skilled in the art to implement or use the present application. Various modifications to these examples will be readily apparent to those skilled in the art, and the generic principles defined herein may be applied to other examples without departing from the spirit or scope of the present application. Thus, the present application is not limited to the examples illustrated herein but is in accordance with the broadest scope consistent with the principles and novel features disclosed herein.

The above description is only of the preferred embodiments of the present application, and it should be noted that those of ordinary skill in the art can make, without departing from the principles of the present application, various improvements and modifications, and such modifications and adaptations shall also be construed within the protection scope of the present application.

1. A method for base calling, comprising:
acquiring an image of interest, wherein the image of interest is generated by imaging during the sequencing of a nucleic acid template on a surface of a solid substrate, the surface of the solid substrate comprises a plurality of reaction sites, and the nucleic acid template is located at the reaction sites;
determining an initial position of the reaction site in the image of interest;
correcting the initial position to determine a desired position of the reaction site in the image of interest;
acquiring a grayscale value of the desired position of the reaction site in the image of interest; and
identifying, on the basis of the grayscale value, the type of a base incorporated into the nucleic acid template.

2-3. (canceled)

4. The method according to claim 1, wherein
the surface of the solid substrate comprises a plurality of first marking lines extending in a first direction and parallel to each other, and a plurality of second marking lines extending in a second direction and parallel to each other; the first direction is non-parallel to the second direction.

5. (canceled)

6. The method according to claim 4, wherein
determining the initial position of the reaction site in the image of interest, comprises:
determining a position of a preset reference point in an intersection region of the first marking line and the second marking line in the image of interest; and
determining the initial position of the reaction site in the image of interest according to the position of the preset reference point in the image of interest.

7. The method according to claim 6, wherein
the plurality of first marking lines and the plurality of second marking lines divide the surface of the solid substrate into a plurality of blocks;
determining the initial position of the reaction site in the image of interest, comprises:
determining initial positions of reaction sites in the first marking line and/or the second marking line in the image of interest on the basis of the preset reference point, and determining initial positions of reaction sites within each block in the image of interest on the basis of the initial positions of the reaction sites in the first marking line and/or the second marking line in the image of interest.

8. The method according to claim 7, wherein
the reaction sites within each block are arranged in an array;
the reaction sites in the first marking line and/or the second marking line are linearly arranged with at least part of the reaction sites within the block;
determining the initial positions of the reaction site within each block in the image of interest on the basis of the initial positions of the reaction sites in the first marking line and/or the second marking line in the image of interest, comprises:
determining the initial positions of the reaction site within each block in the image of interest according to the uniform linear interpolation method and the positions of the reaction sites in the first marking line and/or the second marking line.

9. (canceled)

10. The method according to claim 8, wherein
correcting the initial position to determine the desired position of the reaction site in the image of interest, comprises:
dividing each block in the image of interest into N sub-regions,
wherein each sub-region comprises at least one reaction site in the first marking line and/or the second marking line;
moving the reaction sites in the first marking line and/or the second marking line in the sub-region in the first direction and/or the second direction to correct the initial positions of the reaction sites in the first marking line and/or the second marking line in the image of interest, so as to acquire desired positions of the reaction sites in the first marking line and/or the second marking line in the image of interest;
determining a movement amount of the reaction sites in the first marking line and/or the second marking line from the initial positions to the desired positions; and
correcting the remaining reaction sites in the sub-region based on the movement amount to determine desired positions of the remaining reaction sites in the sub-region in the image of interest,
wherein N is a natural number greater than or equal to 1.

11. The method according to claim 10, wherein
determining the movement amount of the reaction sites in the first marking line and/or the second marking line from the initial positions to the desired positions, comprises:
correcting, after each movement of the reaction sites in the first marking line and/or the second marking line in the sub-region, the remaining reaction sites in the sub-region by the movement amount of the movement, and evaluating the accuracy of the positions of the remaining reaction sites in the corrected sub-region; and
determining the movement amount of the reaction sites in the first marking line and/or the second marking line from the initial positions to the desired positions according to the evaluation result.

12. The method according to claim 10, wherein
determining the movement amount of the reaction sites in the first marking line and/or the second marking line from the initial positions to the desired positions, comprises:
determining a movement amount of moving the reaction sites in the first marking line and/or the second marking line from the initial positions to the desired positions in the i+1^{th} sub-region of the N sub-regions by using a movement amount of moving the reaction sites in the first marking line and/or the second marking line from the initial positions to the desired positions in the i^{th} sub-region of the N sub-regions,
wherein i is a non-zero natural number <N.

13. The method according to claim 12, wherein
determining the movement amount of moving the reaction sites in the first marking line and/or the second marking line from the initial positions to the desired positions in the i+1^{th} sub-region of the N sub-regions by using the movement amount of moving the reaction sites in the first marking line and/or the second marking line from the initial positions to the desired positions in the i^{th} sub-region of the N sub-regions, comprises:
traversing within a preset movement range according to a preset step length on the basis of the movement amount of the reaction sites in the first marking line and/or the second marking line in the i^{th} sub-region from the initial position to the desired position in the i^{th} sub-region;
correcting the remaining reaction sites in the i+1^{th} sub-region by the movement amount of each movement, and evaluating the accuracy of the positions of the remaining reaction sites in the corrected i+1^{th} sub-region; and
determining the movement amount of the reaction sites in the first marking line and/or the second marking line from the initial positions to the desired positions according to the evaluation result.

14. A method for processing image distortion, comprising:
acquiring an image of interest, wherein the image of interest is generated by imaging a surface of a solid substrate, and the surface of the solid substrate comprises a plurality of reaction sites;
determining an initial position of the reaction site in the image of interest; and
correcting the initial position of the reaction site in the image of interest and determining a desired position of the reaction site in the image of interest to eliminate a position bias of the reaction site in the image of interest.

15. The method according to claim 14, wherein
the surface of the solid substrate comprises a plurality of first marking lines extending in a first direction and parallel to each other, and a plurality of second marking lines extending in a second direction and parallel to each other; the first direction is non-parallel to the second direction.

16. (canceled)

17. The method according to claim 15, wherein
determining the initial position of the reaction site in the image of interest, comprises:
determining a position of a preset reference point in an intersection region of the first marking line and the second marking line in the image of interest; and
determining the initial position of the reaction site in the image of interest according to the position of the preset reference point in the image of interest.

18. The method according to claim 17, wherein
the plurality of first marking lines and the plurality of second marking lines divide the surface of the solid substrate into a plurality of blocks;
determining the initial position of the reaction site in the image of interest, comprises:
determining initial positions of reaction sites in the first marking line and/or the second marking line in the image of interest on the basis of the preset reference point, and determining initial positions of reaction sites within each block in the image of interest on the basis of the initial positions of the reaction sites in the first marking line and/or the second marking line in the image of interest.

19. The method according to claim 18, wherein
the reaction sites within each block are arranged in an array;
the reaction sites in the first marking line and/or the second marking line are arranged in a straight line with at least part of the reaction sites within the block.

20. The method according to claim 19, wherein
determining the initial positions of the reaction site within each block in the image of interest on the basis of the initial positions of the reaction sites in the first marking line and/or the second marking line in the image of interest, comprises:
determining the initial positions of the reaction site within each block in the image of interest according to the uniform linear interpolation method and the positions of the reaction sites in the first marking line and/or the second marking line.

21. The method according to claim 19, wherein
correcting the initial position of the reaction site in the image of interest and determining the desired position of the reaction site in the image of interest to eliminate the position bias of the reaction site in the image of interest, comprises:
dividing each block in the image of interest into N sub-regions, wherein each sub-region comprises at least one reaction site in the first marking line and/or the second marking line;
moving the reaction sites in the first marking line and/or the second marking line in the sub-region in the first direction and/or the second direction to correct the initial positions of the reaction sites in the first marking line and/or the second marking line in the image of interest, so as to acquire desired positions of the reaction sites in the first marking line and/or the second marking line in the image of interest;
determining a movement amount of the reaction sites in the first marking line and/or the second marking line from the initial positions to the desired positions; and
correcting the remaining reaction sites in the sub-region based on the movement amount and determining desired positions of the remaining reaction sites in the sub-region in the image of interest to eliminate the position bias of the reaction site in the image of interest,
wherein N is a natural number greater than or equal to 1.

22. The method according to claim 21, wherein
determining the movement amount of the reaction sites in the first marking line and/or the second marking line from the initial positions to the desired positions, comprises:
correcting, after each movement of the reaction sites in the first marking line and/or the second marking line in the sub-region, the remaining reaction sites in the sub-region by the movement amount of the movement, and evaluating the accuracy of the positions of the remaining reaction sites in the corrected sub-region; and
determining the movement amount of the reaction sites in the first marking line and/or the second marking line from the initial positions to the desired positions according to the evaluation result.

23. The method according to claim 21, wherein
determining the movement amount of the reaction sites in the first marking line and/or the second marking line from the initial positions to the desired positions, comprises:
determining a movement amount of moving the reaction sites in the first marking line and/or the second marking line from the initial positions to the desired positions in the i+1^{th} sub-region of the N sub-regions by using a movement amount of moving the reaction sites in the first marking line and/or the second marking line from the initial positions to the desired positions in the i^{th} sub-region of the N sub-regions,
wherein i is a non-zero natural number <N.

24. The method according to claim 23, wherein
determining the movement amount of moving the reaction sites in the first marking line and/or the second marking line from the initial positions to the desired positions in the i+1^{th} sub-region of the N sub-regions by using the movement amount of moving the reaction sites in the first marking line and/or the second marking line from the initial positions to the desired positions in the i^{th} sub-region of the N sub-regions, comprises:
traversing within a preset movement range according to a preset step length on the basis of the movement amount of the reaction sites in the first marking line and/or the second marking line in the i^{th} sub-region from the initial position to the desired position in the i^{th} sub-region;
correcting the remaining reaction sites in the i+1^{th} sub-region by the movement amount of each movement, and evaluating the accuracy of the positions of the remaining reaction sites in the corrected i+1^{th} sub-region; and
determining the movement amount of the reaction sites in the first marking line and/or the second marking line from the initial positions to the desired positions according to the evaluation result.

25. An apparatus for base calling, comprising:
a first acquisition unit, configured for acquiring an image of interest, wherein the image of interest is generated by imaging during the sequencing of a nucleic acid template on a surface of a solid substrate, the surface of the solid substrate comprises a plurality of reaction sites, and the nucleic acid template is located at the reaction sites;
a first determination unit, configured for determining an initial position of the reaction site in the image of interest;
a first correction unit, configured for correcting the initial position to determine a desired position of the reaction site in the image of interest;
a second acquisition unit, configured for acquiring a grayscale value of the desired position of the reaction site in the image of interest; and
an identification unit, configured for identifying, on the basis of the grayscale value, the type of a base incorporated into the nucleic acid template.

26-27. (canceled)
